(19) United States
(12) Patent Application Publication
(10) Pub. No.: US 2008/0229250 A1
(43) Pub. Date: Sep. 18, 2008

(54) METHOD AND SYSTEM FOR NAVIGATION TREE NODE LEVEL CONTROL

(75) Inventors: Thomas S. Brugler, Fuquay-Varina, NC (US); Todd M. Eischeid, Cary, NC (US); Mark E. Molander, Cary, NC (US); Kerry A. Ortega, Raleigh, NC (US)

Correspondence Address: CANTOR COLBURN LLP - IBM TUSCON DIVISION, 20 Church Street, 22nd Floor, Hartford, CT, 06103, US

(73) Assignee: International Business Machines Corporation, Armonk, NY (US)

(21) Appl. No.: 11/685,230

(22) Filed: Mar. 13, 2007

(51) Int. Cl. G06F 3/048

(52) U.S. Cl. 715/854

(57) ABSTRACT

A method for implementing a software based navigational control interface for organizing and presenting a hierarchical user interface structure, includes: displaying the hierarchical user interface structure on a user device; using the navigational control interface to determine which level of the hierarchical user interface structure appears on the same level as an initial root directory; and wherein based on the setting of the navigational control interface the number of hierarchical user interface structure levels is reduced or expanded.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to a software navigational interface, and more particularly to providing a method, article, and system that offers users more control of the way the levels of a navigation tree are organized, and integrates various navigation tree structures within the same navigation area that are easily controllable via one surface control.

2. Description of the Related Art

A tree structure is a type of data structure in which each element is attached to one or more elements directly beneath it. FIG. 1 is an illustration of a basic tree structure 100. The connections between elements (nodes) 102 are called branches (links) 104. Trees are often called inverted trees because they are normally drawn with the root element (node) 106 at the top. The elements at the very bottom of an inverted tree (that is, those that have no elements below them) are called leaves 108. Inverted trees are the data structures used to represent hierarchical file structures. In this case, the leaves 108 are files and the other elements (nodes) (102) and root element (node) (106) above the leaves are directories.

Navigation trees become problematic when they get out of scale, and thus hard to use. A 2-level navigation structure, with 5 to 7 nodes per folder might be ideal, but can be unrealistic. Navigation trees get overstressed with too many levels and too many nodes. Large navigation trees can be especially problematic for large multiple-system management user interfaces.

Not only do navigation trees get hard to use, but other types of similar navigation structures such as drill-down links can also become unwieldy. As a user clicks down a hierarchy of two or three levels, the user can easily get lost or not find the desired target. Sites sometimes post “site maps” to provide a navigation tree within the content area of a page. However, the structure of the site map does not always follow the same model as the drill-down links, as some site maps orient on the lowest-level end nodes by listing them in more of a flattened A-to-Z listing. Therefore, a need has arisen to provide users with more control of the manner in which the levels of a navigation tree are organized.

### SUMMARY OF THE INVENTION

Embodiments of the present invention include a method and system for implementing a software based navigational control interface for organizing and presenting a hierarchical user interface (UI) structure, wherein the method includes: displaying the hierarchical UI structure on a user device; using the navigational control interface to determine which level of the hierarchical UI structure appears on the same level as an initial root directory; and wherein based on the setting of the navigational control interface the number of hierarchical UI structure levels is reduced or expanded.

A system for providing a software based navigational control interface for organizing and presenting a hierarchical UI structure, the system includes: one or more server devices in communication with one or more client devices through a network; the server devices and the client devices configured to execute electronic software that manages the navigational control interface; wherein the electronic software is resident on a storage medium in signal communication with the server devices; wherein the electronic software establishes a hierarchical UI structure; wherein there are user controls on a graphical user interface of the navigational control interface on the client devices; and wherein the user controls determine if the number of hierarchical UI structure levels is reduced or expanded.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for providing users more control of the way the levels of a navigation tree are organized, and integrates various navigation tree structures within the same navigation area that are easily controllable via one surface control. The control essentially surfaces lower-level container nodes as root nodes, and can either be done syntactically and fairly literally (no changes to the navigation tree structure), or with additional semantic optimizations per level of flattening. The navigation control can also be used as a user work-around for poor tree organizations, which is similar to how site maps are often provided for complex problem-prone navigation structures of a web site on the Internet.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a typical tree structure.

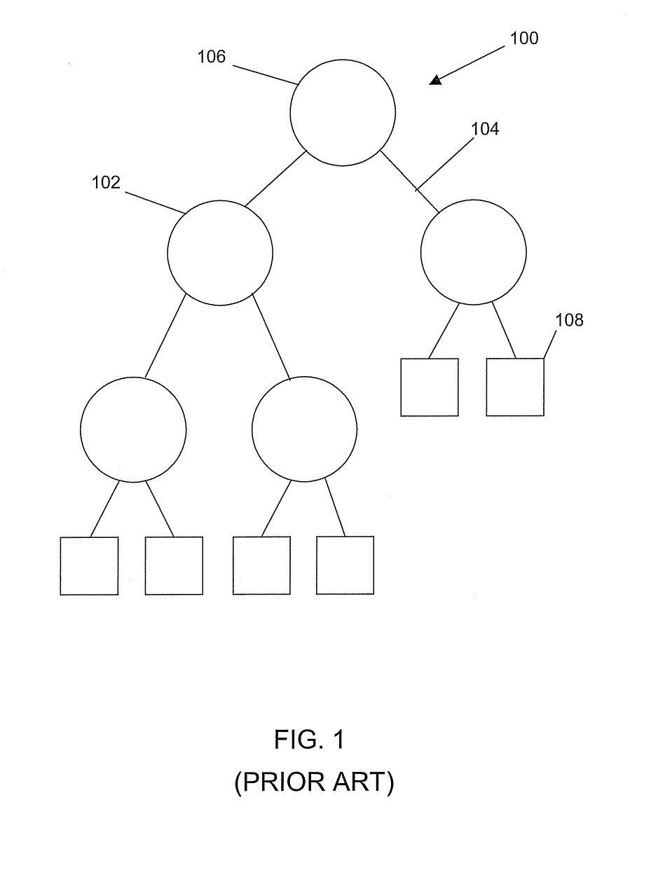

FIG. 2 illustrates a structure and method of controlling the organization of the levels of a navigation tree, in accordance with an embodiment of the invention.

FIG. 3 illustrates a structure and method of controlling the organization of the levels of a navigation tree, including semantics, in accordance with an alternative embodiment of the invention.

FIG. 4 illustrates a system for implementing embodiments of the invention.

The detailed description explains the preferred embodiments of the invention, together with advantages and features, by way of example with reference to the drawings.

### DETAILED DESCRIPTION

Embodiments of the invention provide users with control of the way the levels of a navigation tree are organized, and integrates various navigation tree structures within the same navigation area that are easily controllable via one surface control. The control essentially surfaces lower-level container nodes as root nodes. The surfacing could either be done syntactically and fairly literally (no changes to the navigation tree structure), or with additional semantic optimizations per level of flattening. The embodiments of the invention provide the user a powerful navigation tool to surface lower-level nodes. The navigation tool/control can also be utilized as a user work-around for poor tree organizations, which is similar to how site maps are often provided for complex problem-prone navigation structures of a web site the Internet.

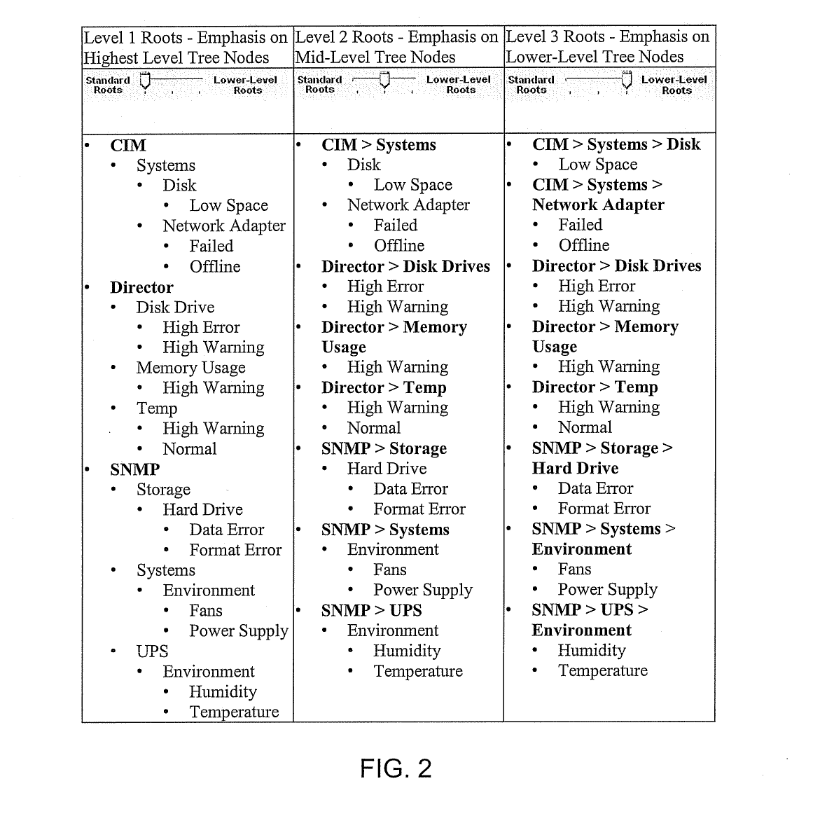

FIG. 2 illustrates an embodiment of the invention utilizing three flattening levels of a navigation tree. The three flattening levels all are based on the same underlying navigation tree data, but with the user controlling how it is organized. The navigation control in the second row of FIG. 2 is shown as a slider control, although other types of controls could also work to set the navigation tree levels (e.g., check boxes, radio buttons, pushbuttons, links, drop-down menu selection, etc.). The navigation control determines which level of tree nodes appears as roots. Stated another way, the user has control of flattening the tree structure. There can be any number of levels of control; for example, FIG. 2 illustrates 3 levels: Level 1 is the default base tree; Level 2 generally promotes the 2nd level nodes to be roots; and Level 3 continues the promotion of yet lower-level nodes to be roots.

The example illustrated in FIG. 2 is a syntactically based—the level changes are fairly simple in that the container/folder nodes typically get promoted per level of “flattening”. When a user moves the control from the farthest left (“Standard Roots”) to the middle position, all the 2nd level tree nodes become roots. In the Level 2 Roots example all of these new roots delineate the original root from the 2nd-level node with a “>” sign, although this could also be done more unobtrusively via fly-over indication of the original root (“Systems” could be labeled as the node, with “CIM” or “CIM>” or “CIM>Systems” appearing on flyover), or more seamlessly by merging together the 2 names (e.g., “CIM Systems” instead of “CIM>Systems”). It will be noted that in the Level 3 example in FIG. 2 that the “Director” roots are not promoted as the user shifts from Level 2 to Level 3, since the end-nodes are not promoted to be roots. However, it might be more optimal to even up the levels among all the branches (“Director” branch was generally a level higher than the other 2 main branches).

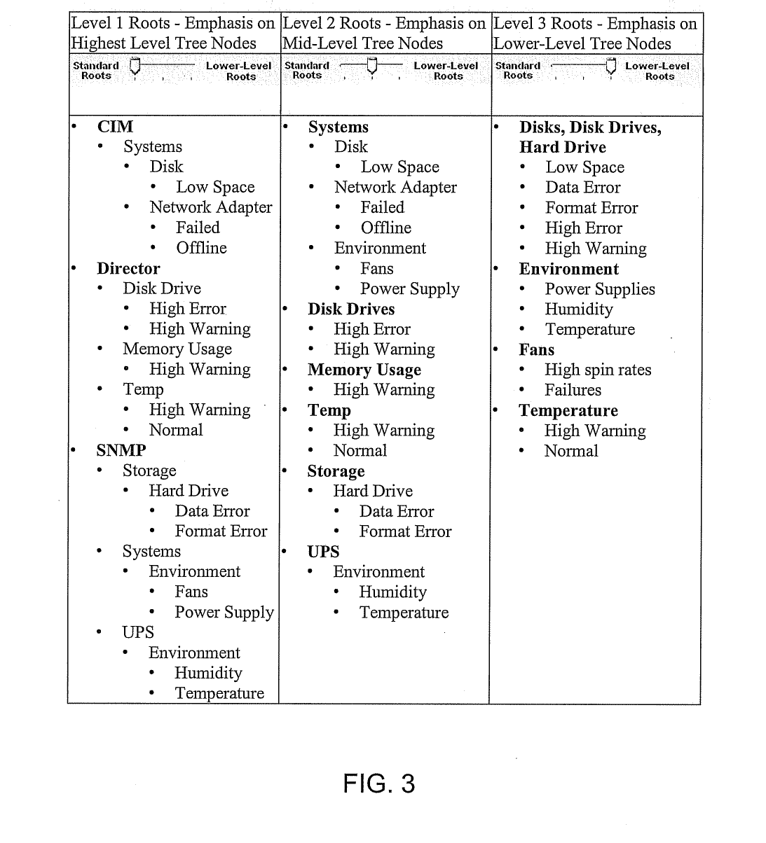

FIG. 3 is a more complex embodiment of the invention that includes some semantics. In FIG. 3 the navigation structure has semantically equated similar nodes within different branches. By semantically equating similar nodes within different branches a reduction in folders is achieved by combining redundant folders. For example, both CIM and SNMP branches have a “Systems” folder, which gets combined at Level 2. Level 3 combines similar nodes at different levels such as things relating to “Disk” and “Disk Drives”. It will be noted that as the navigation tree gets flattened, this example is relying on fly-overs to disclose to user the originating super-ordinate nodes (not shown).

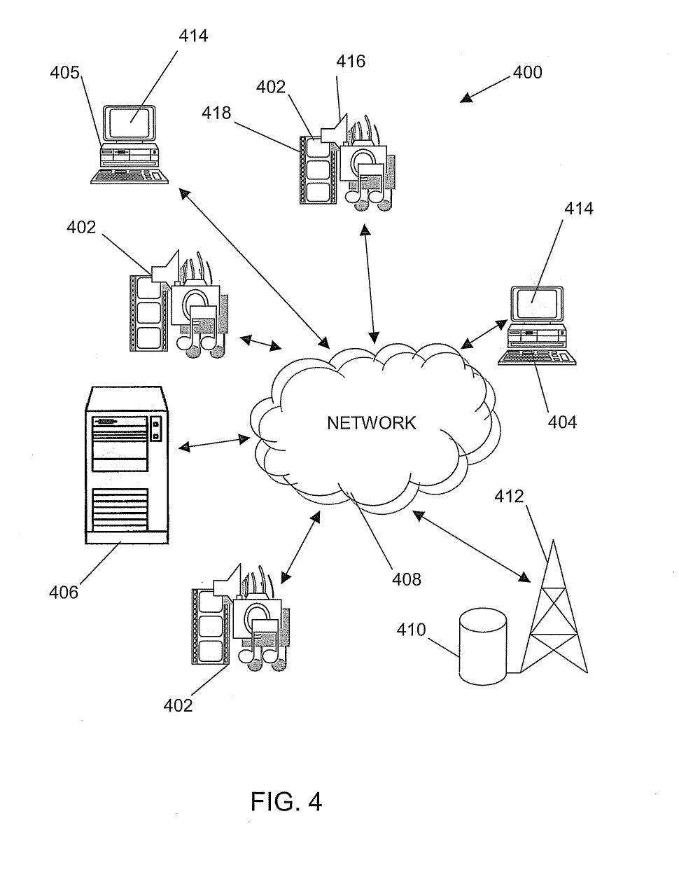

FIG. 4 is a block diagram of an exemplary system 400 for implementing the navigational control interface of the present invention and graphically illustrates how those blocks interact in operation. The system 400 includes remote devices including one or more multimedia/communication devices 402 equipped with speakers 416 for implementing audio, as well as display capabilities 418 for facilitating the graphical user interface (GUI) aspects of the present invention. In addition, mobile computing devices 404 and desktop computing devices 405 equipped with displays 414 for use with the GUI of the present invention are also illustrated. The remote devices 402 and 404 may be wirelessly connected to a network 408. The network 408 may be any type of known network including a local area network (LAN), wide area network (WAN), global network (e.g., Internet), intranet, etc. with data/Internet capabilities as represented by server 406. Communication aspects of the network are represented by cellular base station 410 and antenna 412. Each remote device 402 and 404 may be implemented using a general-purpose computer executing a computer program for carrying out embodiments of the navigational control described herein.

The computer program may be resident on a storage medium local to the remote devices 402 and 404, or maybe stored on the server system 406 or cellular base station 410. The server system 406 may belong to a public service. The remote devices 402 and 404, and desktop device 405 may be coupled to the server system 406 through multiple networks (e.g., intranet and Internet) so that not all remote devices 402, 404, and desktop device 405 are coupled to the server system 406 via the same network. The remote devices 402, 404, desktop device 405, and the server system 406 may be connected to the network 408 in a wireless fashion, and network 408 may be a wireless network. In an exemplary embodiment, the network 408 is a LAN and each remote device 402, 404 and desktop device 405 executes a user interface application (e.g., web browser) to contact the server system 406 through the network 408. Alternatively, the remote devices 402 and 404 may be implemented using a device programmed primarily for accessing network 408 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing a software based navigational control interface for organizing and presenting a hierarchical user interface structure, wherein the method comprises:
displaying the hierarchical user interface structure on a user device;
using the navigational control interface to determine which level of the hierarchical user interface structure appears on the same level as an initial root directory; and
wherein based on the setting of the navigational control interface the number of hierarchical user interface structure levels is reduced or expanded.

2. The method of claim 1, wherein:
using the navigational control interface is facilitated by at least one of the following: slider controls, check boxes, radio buttons, push buttons, links, and drop-down menus.

3. The method of claim 1, wherein:
using the navigational control interface surfaces lower-level container nodes as root nodes; and
wherein the surfacing is based on syntactic rules.

4. The method of claim 1, wherein:
using the navigational control interface surfaces lower-level container nodes as root nodes; and
wherein the surfacing is based on semantic rules.

5. A system for providing a software based navigational control interface for organizing and presenting a hierarchical user interface structure, the system comprising:
one or more server devices in communication with one or more client devices through a network;
the server devices and the client devices configured to execute electronic software that manages the navigational control interface;
wherein the electronic software is resident on a storage medium in signal communication with the server devices;
wherein the electronic software establishes a hierarchical user interface structure;
wherein there are user controls on a graphical user interface of the navigational control interface on the client devices; and
wherein the user controls determine if the number of hierarchical user interface structure levels is reduced or expanded.
